(19) United States
(12) Patent Application Publication
(10) Pub. No.: US 2012/0310542 A1
(43) Pub. Date: Dec. 6, 2012

(54) METHOD FOR DETERMINING A PARAMETER REPRESENTATIVE OF THE STATE OF VIGILANCE OF A VEHICLE DRIVER

(75) Inventor: Betrand Godreau, Toulouse (FR)

(73) Assignee: CONTINENTAL AUTOMOTIVE FRANCE, Toulouse (FR)

(21) Appl. No.: 13/517,454

(22) PCT Filed: Oct. 28, 2010
(86) PCT No.: PCT/EP2010/006597

§ 371 Date: Aug. 27, 2012

(30) Foreign Application Priority Data
Dec. 30, 2009 (FR) 09/06387

(51) Int. Cl. B60W 40/08; G06F 19/00

(52) U.S. Cl. 702/19

(57) ABSTRACT

A method for determining a parameter representative of the state of vigilance of a vehicle driver, from the measurement of the steering wheel angle of the vehicle includes determining two successive ranges of temporal windows: a first range of temporal windows T(t1) extending between ti and ti-t1 with t1min≦t1≦t1max, and a second range of temporal windows T(t2) extending between ti-t1 and ti-t1-t2, with t2min≦t2≦t2max, the two ranges of temporal windows T(t1), T(t2) are scanned and for each of the temporal windows T(t1), T(t2), a datum v(t1), v(t2) is calculated representative of the dispersion of the steering wheel angle values measured during the temporal window. Finally, for each pair of temporal windows T(t1)-T(t2), the ratio v(t1)/v(t2) is calculated, and the ratio v(t1)/v(t2) with the maximum value is selected as the value representative of the state of vigilance of the driver.

The invention relates to a method for determining a parameter representative of the state of vigilance of a vehicle driver.

When analyzing the behavior of drivers, it has been established that a phase of activity following a phase of relative inactivity could prove representative of a lowering of vigilance of the driver. These findings have been chiefly used for implementing a method for determining a parameter representative of the state of vigilance of a driver disclosed in patent EP1548678, based on measurements of the steering wheel angle and determining the ratio of variances of these values for two successive temporal windows each having a predetermined duration. However, notably because of the difficulties of determining the parameters necessary for its implementation (size of temporal windows, etc.), this method proves to be of very limited accuracy and therefore reliability.

The present invention is aimed at overcoming this drawback and has as its main objective to provide a reliable and accurate method for determining a parameter representative of the state of vigilance of a driver from the measurement of the steering wheel angle of a vehicle.

To this end, the invention is aimed at a method for determining a parameter representative of the state of vigilance of a vehicle driver, from the measurement of the steering wheel angle of said vehicle, said method consisting, at each sampling instant ti, in:
determining two ranges of successive temporal windows: a first range of temporal windows T(t1) extending between ti and ti-t1 with t1min≦t1≦t1max, and a second range of temporal windows T(t2) extending between ti-t1 and ti-t1-t2, with t2min≦t2≦t2max,
scanning the two temporal window ranges T(t1), T(t2) by varying the values t1 and t2 between their minimum and maximum values, and calculating, for each of the temporal windows T(t1), T(t2), a datum respectively v(t1), v(t2) representative of the dispersion of the values of the steering wheel angle measured during said temporal window,
calculating, for each pair of temporal windows T(t1)-T(t2), the ratio v(t1)/v(t2) of the corresponding values v(t1), v(t2), and selecting as the value representative of the state of vigilance of the driver at instant ti, the ratio v(t1)/v(t2) with the maximum value.

Such a method, at each sampling, leads to determining the pair of temporal windows T(t1), T(t2) corresponding to the highest ratio of values representative of the dispersion of measurements of the steering wheel angle, i.e., for the period preceding the sampling, the datum most representative of a possible quiet phase/active phase event.

This method can thus be used to limit the study of the ratio of the values representative of the dispersion of measurements to the study of its local maxima, and thus to detect the exact date of the quiet phase/active phase event without further requiring the preliminary setting of a threshold on the dispersion values or a size for the temporal windows.

Such a method thus proves to lead, reliably and accurately, to determining a parameter that is directly usable for assessing the state of vigilance of a driver.

According to an advantageous embodiment of the invention, the first range of temporal windows T(t1) extends between a minimum duration adapted to allow approximately 5 measurements of the steering wheel angle and a maximum duration adapted to allow approximately 200 measurements of the steering wheel angle. Also advantageously, the second range of temporal windows T(t2) extends between a minimum duration adapted to allow approximately 30 measurements of the steering wheel angle and a maximum duration adapted to allow approximately 80 measurements of the steering wheel angle.

Thus with a sampling frequency having a value advantageously equal to 10 Hertz, the range of temporal windows T(t1) extends between 500 ms and 20 s while the range of temporal windows T(t2) extends between 3 s and 8 s.

Moreover, the datum v(t1), v(t2) representative of the dispersion of the measured values of the steering wheel angle advantageously and ordinarily consists of the variance of said values.

The method according to the invention will be better understood upon reading the following detailed description with reference to the accompanying drawings which show:

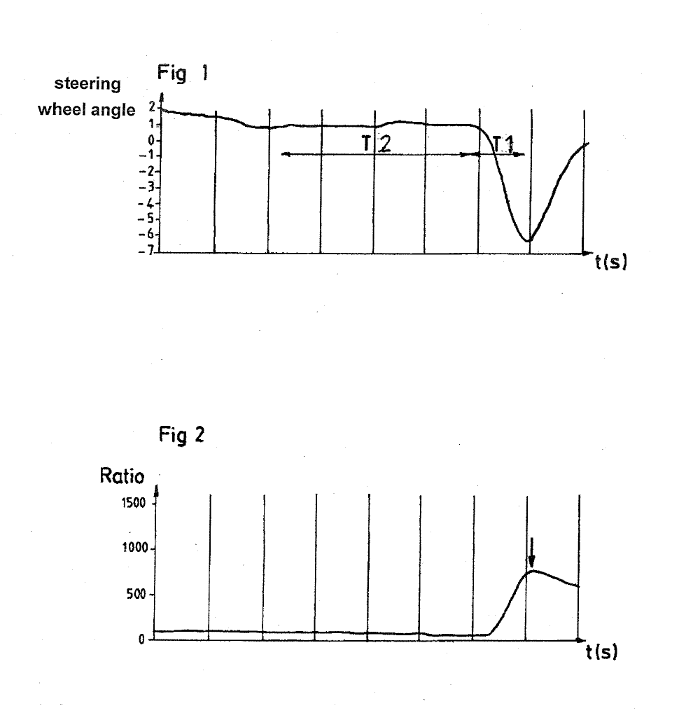

FIG. 1, a curve representative of the variations over a period of a few seconds of the steering wheel angle of a vehicle,

and FIG. 2, the corresponding curve of variations in the ratio of variances determined according to the invention.

The method according to the invention disclosed below with reference to the accompanying drawings consists of a method for detecting, from measurements of the steering wheel angle of a vehicle carried out with a sampling frequency of 10 Hertz, the sequence of a calm phase followed by an active phase, i.e. a sequence as shown in FIG. 1 (in which the abscissa scale is 1 second, and which thus represents the change in the steering angle over a period of 8 seconds).

According to this method and in the first place, two ranges of successive temporal windows are determined: one range of temporal windows T(t1) extending between 500 ms and 20 s and one range of temporal windows T(t2) extending between 3 s and 8 s.

At each sampling instant ti, this method consists in scanning the two ranges of temporal windows by varying the range T(t1), starting from ti, between a minimum value of 500 ms and a maximum value of 20 s, and the range T(t2), starting from ti-t1, between a minimum value of 3 s and a maximum value of 8 s.

The calculation of the variances v(t1), v(t2) of the steering wheel angle values obtained for each temporal window can then be used to determine the highest v(t1)/v(t2) ratio.

As shown in the figures, the successive samplings can be used to obtain the curve shown in FIG. 2, which proves to constitute a faithful picture of the variations in the steering wheel angle (amplitude, event dates, etc.) directly usable for determining the state of vigilance of the driver.

In addition, the data collected also include, as shown in FIG. 1, the durations T1 and T2 of the temporal windows corresponding to the maximum ratio calculated, and these data can also constitute parameters for refining and improving the interpretation of the results.

1. A method for determining a parameter representative of the state of vigilance of a vehicle driver, from the measurement of the steering wheel angle of said vehicle, characterized in that it consists, at each sampling instant ti, in:
determining two ranges of successive temporal windows: a first range of temporal windows T(t1) extending between ti and ti-t1 with t1min≦t1≦t1max, and a second range of temporal windows T(t2) extending between ti-t1 and ti-t1-t2, with t2min≦t2≦t2max,
scanning the two temporal window ranges T(t1), T(t2) by varying the values t1 and t2 between their minimum and maximum values, and calculating, for each of the temporal windows T(t1), T(t2), a datum respectively v(t1), v(t2) representative of the dispersion of the values of the steering wheel angle measured during said temporal window,
calculating, for each pair of temporal windows T(t1)-T(t2), the ratio v(t1)/v(t2) of the corresponding values v(t1), v(t2), and selecting as the value representative of the state of vigilance of the driver at instant ti, the ratio v(t1)/v(t2) with the maximum value.

2. The method as claimed in claim 1, characterized in that:
the first range of temporal windows T(t1) extends between a minimum duration adapted to allow approximately 5 measurements of the steering wheel angle and a maximum duration adapted to allow approximately 200 measurements of the steering wheel angle,
the second range of temporal windows T(t2) extends between a minimum duration adapted to allow approximately 30 measurements of the steering wheel angle and a maximum duration adapted to allow approximately 80 measurements of the steering wheel angle.

3. The method as claimed in claim 1, characterized in that the datum v(t1), v(t2) representative of the dispersion of the measured values of the steering wheel angle consists of the variance of said values.

4. The method as claimed in claim 1, characterized in that the sampling frequency is 10 Hertz.

5. The method as claimed in claim 2 characterized in that the datum v(t1), v(t2) representative of the dispersion of the measured values of the steering wheel angle consists of the variance of said values.

6. The method as claimed in claim 2 characterized in that the sampling frequency is 10 Hertz.

7. The method as claimed in claim 3 characterized in that the sampling frequency is 10 Hertz.
